(19) United States
(12) Patent Application Publication
(10) Pub. No.: US 2014/0036538 A1
(43) Pub. Date: Feb. 6, 2014

(54) COATINGS TO ELIMINATE LED HOT SPOTS

(71) Applicant: APPLE INC., Cupertino, CA (US)

(72) Inventors: Chenhua You, San Jose, CA (US); Jean-Jacques P. Drolet, San Jose, CA (US)

(73) Assignee: Apple Inc., Cupertino, CA (US)

(21) Appl. No.: 13/665,678

(22) Filed: Oct. 31, 2012

Related U.S. Application Data
(60) Provisional application No. 61/677,982, filed on Jul. 31, 2012.

(51) Int. Cl. G09F 13/04; F21V 8/00; H01J 9/24; B82Y 20/00

(52) U.S. Cl. 362/613; 445/24; 362/97.1; 977/774

(57) ABSTRACT

A display that contains a backlight that incorporates an optical coating either on or above the light guide in order to reduce the appearance of optical hotspots on the display is provided. The optical coating can be patterned to correspond to the position of each light emitting diode in the display and can be made, as an example, from either reflective, diffusive or dichroic material. The coating can work to overcome the hotspots created by insufficient light mixing distance in the backlight.

### FIELD OF THE DISCLOSURE

This relates generally to the use of optical coatings to eliminate light emitting diode (LED) hotspots, and more particularly, to the placement of an optical coating near an LED or a quantum dot sheet to normalize the intensity of light emanating from a backlight.

### BACKGROUND OF THE DISCLOSURE

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., mobile telephones, tablet computers, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

Liquid crystal displays generally are made up of a back light that provides visible light to a liquid crystal layer. which takes the light from the backlight and controls the brightness and color at each individual pixel in the display in order to render a desired image.

The backlight often contains light emitting diodes that are coated with a phosphor such as Yttrium Aluminum Garnet (YAG) in order to produce a white light or red, green and blue light, which the liquid crystal layer then uses to render desired colors for the display. Quantum dots can also be used in place of a YAG phosphor to improve color fidelity of the display. One metric that can be used to judge the quality of a display is the uniformity of brightness of color across an entire display screen produced by the backlight. In both YAG phosphor and quantum dot displays, when an LED produces one color directly and uses YAG or quantum dots to produce the other colors, the uniformity of brightness of the color can be compromised. The non-uniformity in brightness of the color can be referred to as hotspots on an LED driven display. Hotspots can be mitigated by placing an optical coating proximal to either a YAG phosphor or quantum dot sheet. The optical coating, for example, can be diffusive, reflective, or can be an optical filter and can serve to normalize the intensity of each color in the display.

### SUMMARY OF THE DISCLOSURE

This relates to display backlights that utilize an optical coating in order to reduce the appearance of hotspots on the display caused by insufficient light mixing distance.

The optical coating can be disposed on top of a backlight light guide or be applied as part of the light guide, and can be made from reflective, diffusive or dichroic material. The optical coating can be patterned to the relative positions of each LED in the display backlight architecture.

### BRIEF DESCRIPTION OF THE DRAWINGS

FIG. 1A illustrates an example mobile telephone that includes a display screen according to some disclosed examples.

FIG. 1B illustrates an example digital media player that includes a display screen according to some disclosed examples.

FIG. 1C illustrates an example personal computer that includes a display screen according to some disclosed examples.

FIG. 1D illustrates an example tablet computing device that includes a display screen according to some disclosed examples.

FIG. 2A illustrates an exemplary display screen stack-up according to some disclosed examples.

FIG. 2B illustrates exemplary layers of an LCD display screen stack-up according to some disclosed examples.

FIG. 3 illustrates an exemplary backlight according to some disclosed examples.

FIG. 4 illustrates an exemplary quantum dot sheet according to some disclosed examples.

FIG. 5 illustrates an exemplary backlight that utilizes a quantum dot sheet according to some disclosed examples.

FIG. 6A illustrates an exemplary quantum dot display that utilizes an optical coating to mitigate hotspots according to some disclosed examples.

FIG. 6B illustrates a magnified view of the exemplary quantum dot display that utilizes an optical coating to mitigate hotspots of FIG. 6A according to some disclosed examples.

FIG. 6C illustrates a cross-section of a quantum dot display that utilizes a direct view configuration.

FIG. 7A illustrates an exemplary frequency response of a dichroic film that can be used as an optical coating.

FIG. 7B illustrates another exemplary frequency response of a dichroic film that can be used as an optical coating.

FIG. 8 is a block diagram of an example computing system that illustrates one implementation of an example display with the optical coating to mitigate hotspots quantum dots according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

This relates to a backlight architecture in a display that can employ an optical coating layer to mitigate hotspots created by non-uniformities in light intensity over the display area. By placing an optical coating layer such as a dichromatic film, diffuser or reflector proximal to a phosphor or quantum dot layer, hotspots can be reduced in intensity so that the intensity of light can be more uniform over the surface of the display.

Although examples disclosed herein may be described and illustrated herein in terms of displays that utilize side emitting light emitting diodes (LED), it should be understood that the examples are not so limited, but are additionally applicable to top emitting LEDs or bottom emitting LEDs. Furthermore, although examples may described in terms of displays, it should be understood that the examples are not so limited, but can be additionally applicable to displays that are integrated with touch screens which can accept touch inputs from a user or object such as a stylus.

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., mobile telephones, tablet computers, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

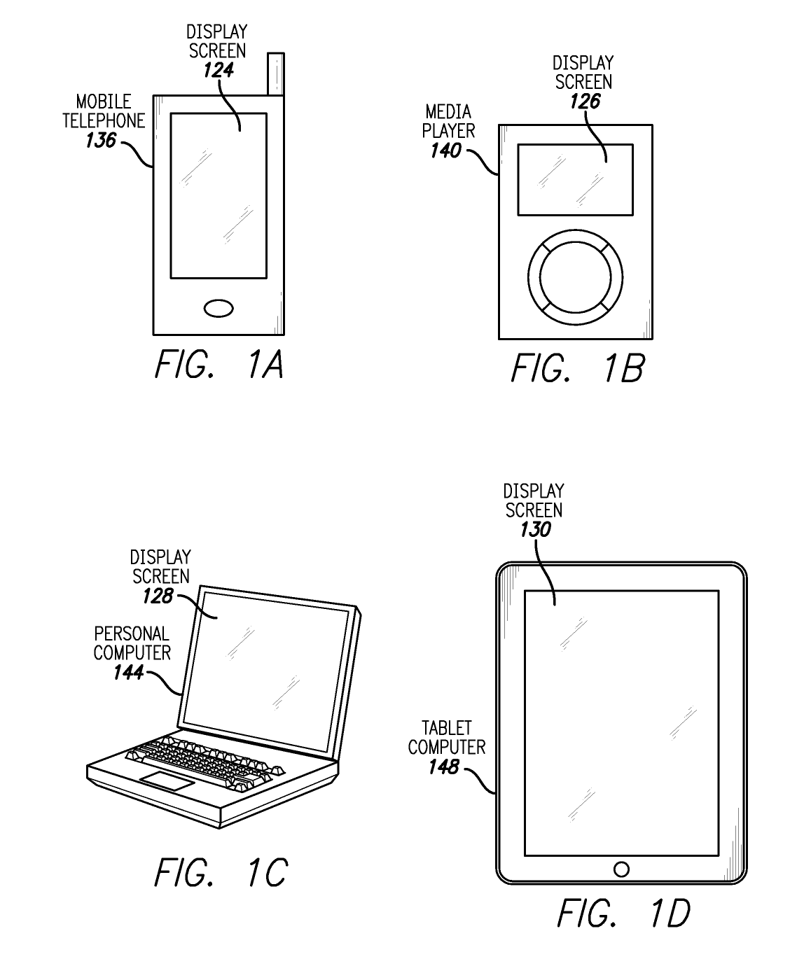

FIGS. 1A-1D show example systems in which display screens (which can be part of touch screens) according to examples of the disclosure may be implemented. FIG. 1A illustrates an example mobile telephone 136 that includes a display screen 124. FIG. 1B illustrates an example digital media player 140 that includes a display screen 126. FIG. 1C illustrates an example personal computer 144 that includes a display screen 128. FIG. 1D illustrates an example tablet computing device 148 that includes a display screen 130. LCD display screens 124, 126, 128 and 130 can include numerous layers that are stacked on top of each other and bonded together to form the display.

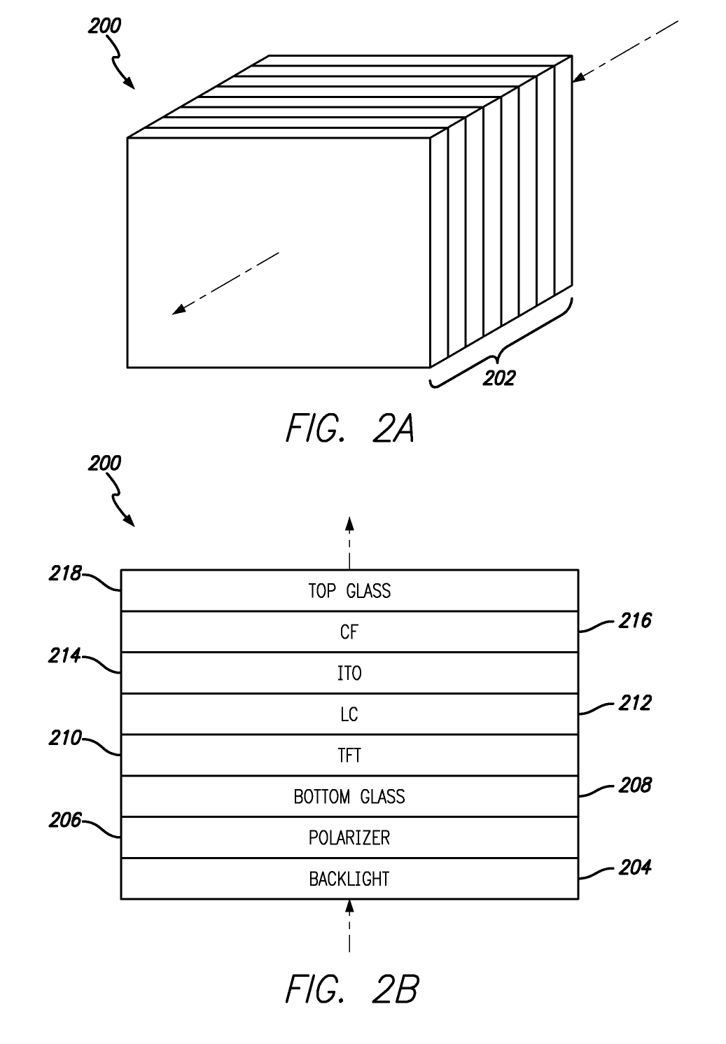

FIG. 2A illustrates an exemplary display screen stack-up according to some disclosed examples. Display screen 200 can contain a series of layers 202 that can be bonded or otherwise attached together to constitute the display. FIG. 2B illustrates exemplary layers of an LCD display screen stack-up according to some disclosed examples. Backlight 204 can provide white light that can be directed towards the aperture of the stack-up. As will be discussed below, the backlight can supply the rest of the display stack-up with light that can be oriented in particular orientation based on the needs of the rest of the stack-up. In order to control the brightness of the light, the white light produced by the backlight 204 can be fed into a polarizer 206 that can impart polarity to the light. The polarized light coming out of polarizer 206 can be fed through bottom glass 208 into a liquid crystal layer 212 that can be sandwiched between an Indium Tin Oxide (ITO) layer 215 and a Thin Film Transistor (TFT) layer 210. TFT substrate layer 210 can contain the electrical components necessary to create the electric field, in conjunction with ITO layer 214 that drives the liquid crystal layer 212. More specifically, TFT substrate 210 can include various different layers that include display elements such as data lines, gate lines, TFTs, common and pixel electrodes, etc. These components can help create a controlled electric field that orients liquid crystals located in liquid crystal layer 212 into a particular orientation, based on the desired color to be displayed at any particular pixel. The orientation of a liquid crystal element in liquid crystal layer 212 can alter the orientation of the polarized light that is passed through it from backlight 204. The altered light from liquid crystal layer 212 can then be passed through color filter layer 216. Color filter layer 216 can contain a polarizer. The polarizer in color filter layer 216 can interact with the polarized light coming from liquid crystal layer 212, whose orientation can be altered depending on the electric field applied across the liquid crystal layer. The amount of light allowed to pass through color filter layer 216 into top glass 218 can be determined by the orientation of the light as determined by the orientation of the liquid crystal layer 212. By polarizing the white light coming out of back light 204, changing the orientation of the light in liquid crystal layer 212, and then passing the light through a polarizer in color filter layer 216, the brightness of light can be controlled on a per pixel basis. Color filter layer 216 also can contain a plurality of color filters that can change the light passed through it into red, green and blue. By controlling the brightness and color of light on a per pixel basis, a desired image can be rendered on the display.

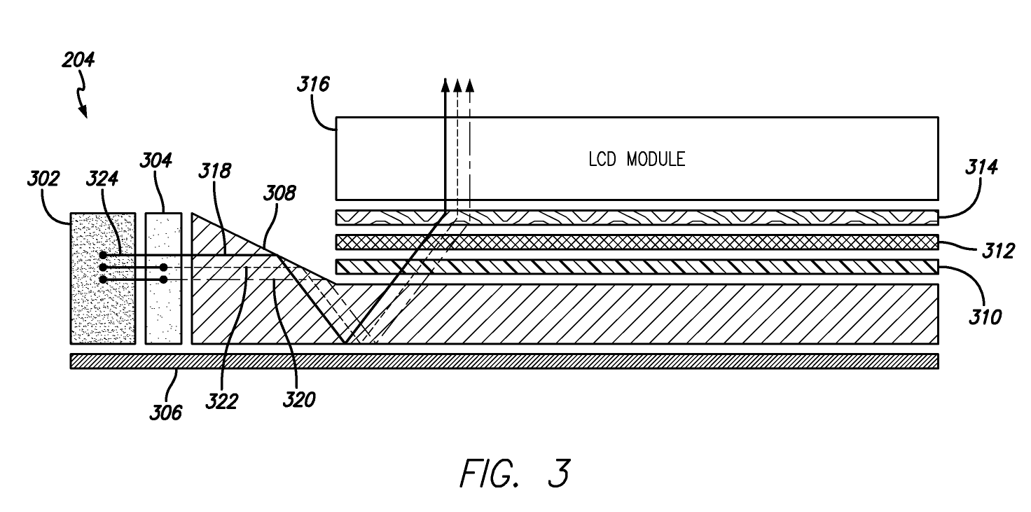

FIG. 3 illustrates an exemplary backlight according to some disclosed examples. Backlight 204 can be made up of a plurality of elements that can be arranged so as to provide white light to the rest of display stack-up 200. Backlight 204 can contain light emitting diode (LED) 302, which can act as the primary light source for the entire display stack-up 200. As pictured, LED 302 can be a side emitting LED. The light generated by LED 302 can irradiate a phosphor 304 that can produce a light of a particular color or colors when excited by light source such as an LED. As an example, the phosphor 304 can contain a Yttrium Aluminum Garnet (YAG) coating in order to produce red and green light. The light emitted from the phosphor 304 can then be fed into light guide 308, which in conjunction with reflective plate 306 can work to turn the light being emitted from the side emitting LED 302 into the LCD module. The light that is emitted upwards toward the LCD module 316 can first enter diffuser sheet 310. Diffuser 310 can act to mix the red, green and blue light emitted from phosphor 304 in order to create white light. The light that passes through diffuser sheet 310 can also be fed into a prism sheet 312 which can act to turn the light further, so that it can enter the LCD module perpendicular to its bottom plane. The mixed light from prism sheet 312 can then be fed into a second diffuser sheet 314 that can again mix the light.

In one example of a backlight implementation, the LED 302 can produce a blue light that can be used to illuminate a YAG phosphor layer 304 that can be configured to output red and green wavelengths of light when excited by the LED. As shown in FIG. 3, LED 302 can produce a blue light 324. Some of the blue light 324 can be passed through YAG phosphor layer 304 without interacting with the phosphor and be directly fed in light guide 608. Some of the blue light can be used to excite particles on the YAG phosphor layer. For example, blue light 324 from LED 302 can excite particles in the YAG phosphor layer 304 that are configured to produce red light 320 when excited by a light source. Other particles in the YAG phosphor layer 304 can be configured to produce green light 322 when excited by a light source. For illustrative purposes, blue light 324, green light 322 and red light 320 are shown as separate beams, however one skilled in the art would recognize that the light beams can be mixed together and not separated as shown. By allowing some blue light to pass through as a beam of light 318, and by emitting red and green light 320 and 322 when stimulated by an energy source, the YAG phosphor layer 304 can be made to emit red, green and blue light that will be fed into light guide 308, and be directed by diffuser sheets 310 and 314 and prism sheets 312 and mixed in order to provide directional white light for use by the LCD module 216.

In some instances, the distance that the light emitted from LED 324 travels before reaching the viewer of the display is insufficient to allow the individual beams of light to property mix. For instance, the insufficient distance can prevent the light from properly mixing, thus potentially causing the blue light beam 318 to appear to have more intensity in contrast to the red and green light beams 320 and 322. The imbalance in intensity between the blue light beam 319 and the red and green light beams 320 and 322 may be visible to the user. The user may see “hotspots” on the display in which certain spots on the display appear brighter.

Hotspots can also be caused by LED position. For example, when LEDs are placed in the active area (the area visible to the user) of a display, insufficient mixing of light can cause the individual LEDs to become visible to the user. In other words in addition to the mixture of colors created to render images, a user may be able to see visual artifacts in the image that appear as bright spots on the image corresponding to individual LEDs of the display.

In the example of edge emitting LEDs, the edges of an active region corresponding to the edge in which the LEDs are disposed may appear brighter than the rest of the active region due to insufficient mixing of light.

The same hotspot phenomenon observed in YAG phosphor backlights can also be present in displays that utilize quantum dots. Quantum dots (QDs) are nanocrystal phosphors that can be about 2-10 nm in size. They can be distinguishable from bulk semiconductor material (used to fabricate LEDs) not only in size, but also by their energy levels. The energy levels in bulk material can be so close together that the levels can be essentially continuous; however, quantum dots can contain only two discrete energy bands that can be occupied by the electrons. The valence band is located below the bandgap and the conduction band is located above the bandgap. When an electron in the valence band is imparted with sufficient energy to surmount the bandgap, it can become excited and jump to the conduction band. The electron will then want to return to its lowest energy state, and in doing so, can release energy in the form of electromagnetic radiation. The electron will fall back down to the valence band, emitting a photon with wavelength corresponding to the wavelength of radiation or the bandgap energy. For quantum dots, their small size can lead to quantum confinement, where the energy levels can become discrete and quantized with finite separation. When the quantum dots are excited, the electromagnetic radiation corresponding to the wavelength can be released in the form of light. The main difference relative to bulk material is that the discrete energy levels for the QDs can allow for precise tunability of the emitted photon. For quantum dots, the energy levels can be finely tuned based on the size of the dot, which in turn can lead to tuning the wavelength of the emitted photon. This tunability can allow the QDs the ability to emit nearly any frequency of light, a quality that bulk semiconductor material, and hence a stand-alone, standard light-emitting diode (LED) lacks. The quantum dots can be tuned to emit colors at more precise wavelengths relative to YAG phosphors with narrower spectral emission and a smaller full width at half maximum (FWHM) bandwidth. The heightened spectral precision of quantum dots can allow the color filter in color filter layer 216 to be narrowed, thus improving both the color quality and color gamut of the display. Quantum dots can be formed on a sheet that is placed within the display, so that it can be exposed to the light produced by the LED 302.

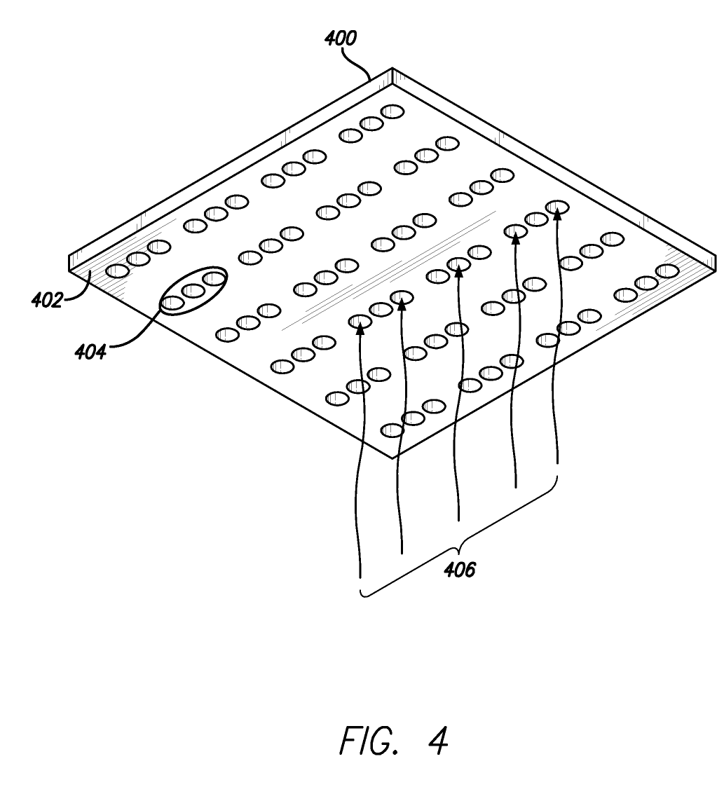

FIG. 4 illustrates an exemplary quantum dot sheet according to disclosed examples. Quantum dot sheet 400 can contain individual quantum dots 402. The quantum dots 402 can be arranged in groups 404, such that each group can contain, for example, three quantum dots, one red, one green and one blue, such that the light generated by each group when mixed together can produce white light. In other examples, a blue LED can be used to excite the quantum dots, obviating the need for a quantum dot that emits blue light, and thus group 404 may contain only a red and green quantum dot. Thus the red and green light emitted from the quantum dots can be mixed with the light from a blue LED that is passed through the quantum dot sheet to form white light. Quantum dot sheet 400 can be excited by a light source 406. Light source 406 can be light emitted from an LED. In some examples, light source 406 can be ultra violet (UV) light. Light source 406 can provide the energy required to excite the quantum dots so that they emit photons of light at precisely tuned wavelengths. The wavelengths can be tuned by adjusting the size of the quantum dots. When light source 406 excites quantum dot 402, each quantum dot can release light. An excited quantum dot can release isotropic light. In other words, the light emitted from a quantum dot can be emitted uniformly in all directions from the quantum dot. This feature of quantum dots can play a significant role in determining where in the display architecture to integrate the quantum dot sheet 400.

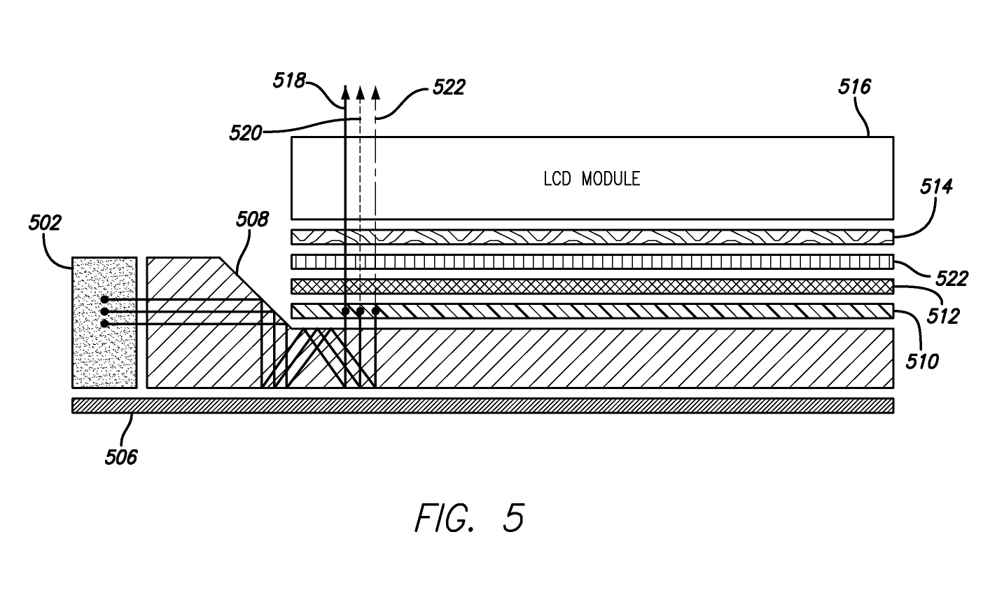

FIG. 5 illustrates an exemplary backlight that utilizes a quantum dot sheet according to some disclosed examples. Edge emitting LEDs 502 can act as a light source that can direct light into light guide 508. The light guide path can then spatially distribute and direct the light out of the light guide path along the length of the path. The light guide path can be optimized to direct light upwards. Some of the light coming out of the light guide path can hit the quantum dot sheet 510 and excite the quantum dots, transforming the light into the appropriate color depending on excitation energy. The quantum dot sheet 510 can be tuned for a certain angle of incoming light, and its spatial uniformity can be optimized. The distribution of quantum dots or the thickness of the quantum dot sheet can be controlled such that the distribution of colors seen at the top of the display can be equal. The light that does not excite the quantum dots can pass through the QD sheet and can be collimated and off axis, so the light may need to be made isotropic to match the characteristics of the light from the quantum dots. The light can then pass through a bottom prism sheet 512 and top prism sheet 514 to direct the angle of light upwards towards the liquid crystal module 516 and the top of the display. In this example, as illustrated, a diffuser sheet 522 can be disposed between bottom prism sheet 512 and top prism sheet 514. The purpose of the diffuser sheet 522 can be to make the light that has passed through the quantum dot sheet isotropic and to further mix this light with the light emitted from the quantum dots.

Similar to the YAG phosphor backlight architecture discussed above and illustrated in FIG. 3, the quantum dot sheet 610 can be configured such that some of the blue light beam 518 emitted by LED 502 can be allowed to pass through the quantum sheet, while some of the light can be used to excite quantum dots to produce red light beam 520 and green light beam 522. However configuring the backlight architecture in this manner can cause possible hotspots to appear on the display in the same manner as discussed above with respect to the YAG phosphor backlight of FIG. 3. In some examples, an additional diffuser sheet can be placed between the top prism sheet 514 and the liquid crystal module 516 for further light mixing, to compensate for any non-uniformities, or to account for hotspots. However, adding an additional prism sheet can add thickness to the display.

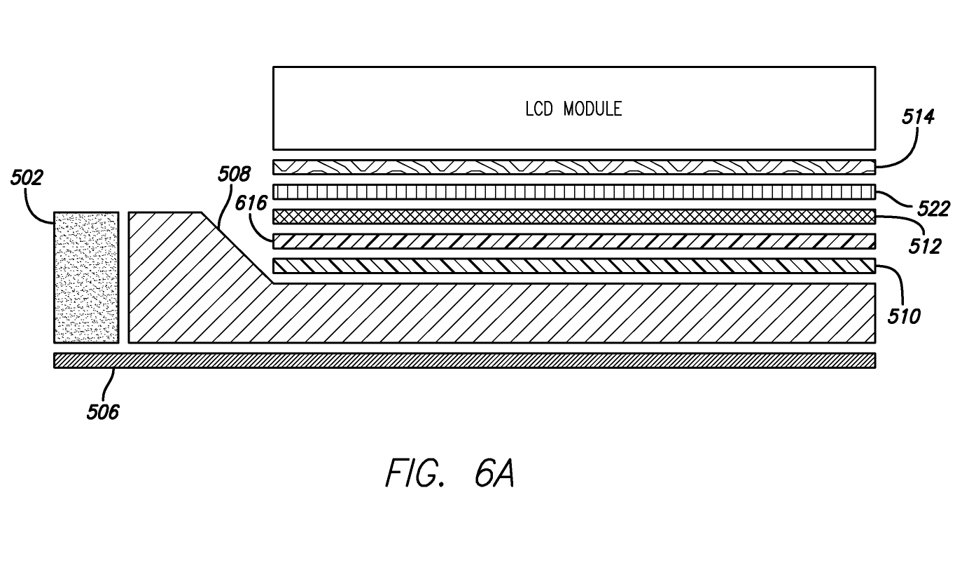

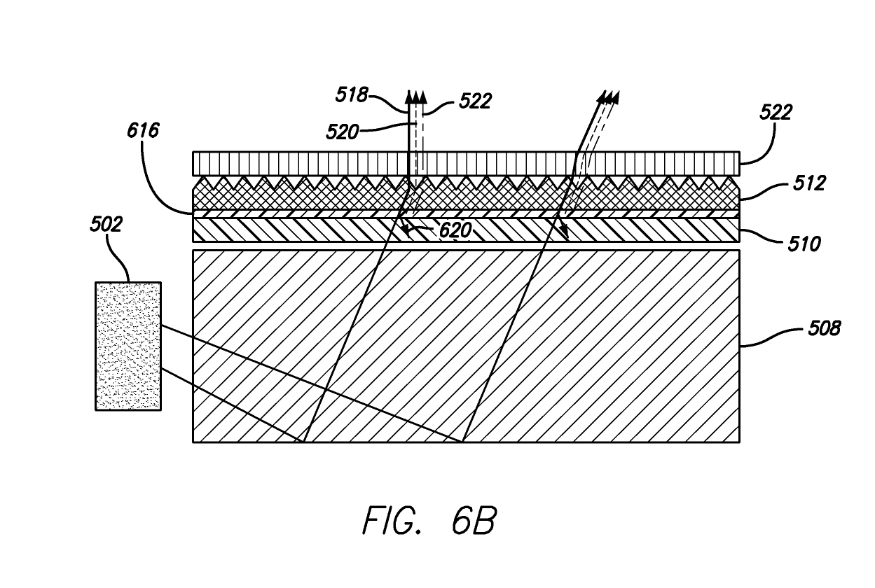

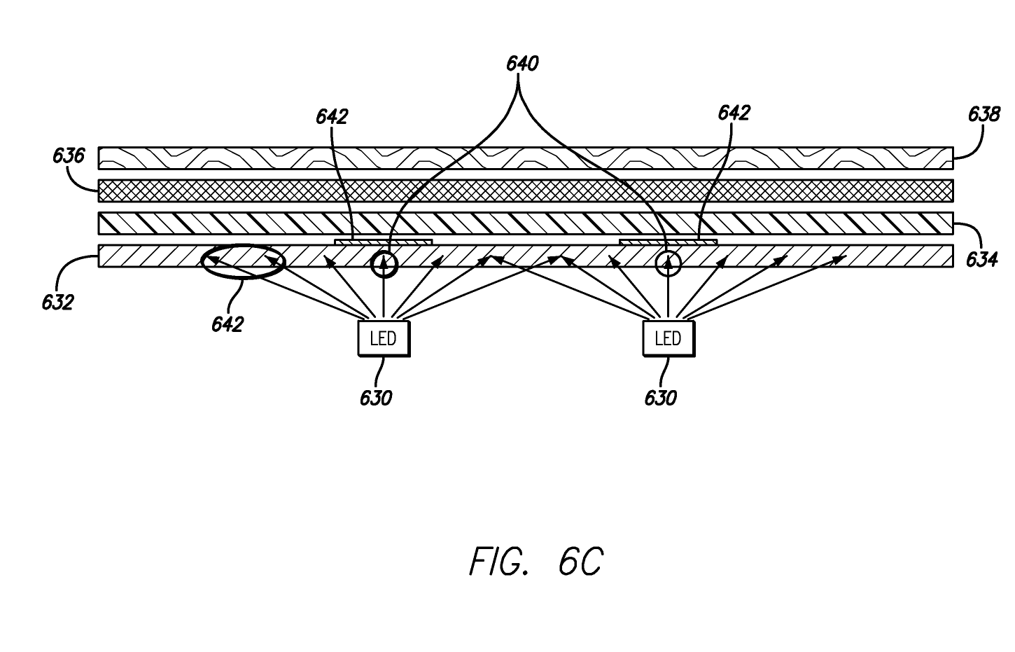

FIG. 6A illustrates an exemplary quantum dot display that utilizes an optical coating to mitigate hotspots according to disclosed examples. The display illustrated is the same display of FIG. 5, with an optical coating layer 616 added. Optical coating layer 616 can be implemented by inserting an additional layer of optical material between quantum dot sheet 510 and bottom prism sheet 512. This implementation can add thickness to the overall display. Alternatively, optical layer 616 can be implemented by applying a coating to quantum dot sheet. This implementation can be beneficial in that the thickness of the over display may not increase, or may only marginally increase. The optical coating can be patterned relative to individual LED positions to account for the hotspots created by individual LEDs. Furthermore the optical coating can be patterned so that they are disposed only in areas where hotspots have a higher propensity of occurring. In areas where hotspots are less likely to occur, an optical coating may not be required. Thus optical coatings can be localized to areas where hotspots may occur.

FIG. 6B illustrates a magnified view of the exemplary quantum dot display that utilizes an optical coating to mitigate hotspots of FIG. 6A according to disclosed examples. As illustrated, LED 502 can emit a blue light into light guide 508. Light guide 508 can then re-direct the light toward quantum dot sheet 510. As discussed above, the blue light emitted by LED 502 can be partially passed through the quantum dot sheet 510, while some of the blue light can be used to stimulate a red quantum dot and a green quantum dot. In this configuration, the quantum dot sheet 510 can emit the blue, red and green light necessary to produce the white color that can be desirable for the display. In order to mitigate the hotspot phenomenon discussed above, an optical coating 616 can be used. In one example, the optical coating 616 can be a reflective coating made, for example, with aluminum, silver, or an alloy. The reflective material in optical coating 616 can act to selectively attenuate the intensity of blue light seen by the user of the display, so that the intensity of the blue, green, and red light used to render images by the display can be uniform through the entire surface of the display. Thus, the appearance of hotspots on the display can be minimized or even eliminated. As shown, when light from the quantum dot sheet 510 is passed through optical coating 616, some of the blue light 518 can be passed through, while some of the blue light 520 can be directed towards the light guide. Since some of the light is reflected away from the sight of the user, the appearance of hotspots can be minimized. In another example, the optical coating 616 can be a diffuser. A diffuser coating can work similarly to a reflective coating, by allowing some of the blue light to be transmitted, while directing some of the blue light away from the sight of the viewer, thus minimizing the appearance of hotspots on the display.

FIG. 6C illustrates a cross-section of a quantum dot display that utilizes a direct view configuration. As described above, a direct view configuration utilizes LEDs that are disposed within the active area of a display (the area visible by the user). In this example LEDs 630 can be disposed in the active area of the display and are top emitting LEDs. LEDs 630 emit light into a quantum dot sheet, which then produces the colors required by the display to render desired images. The light emitted from quantum dot sheet 632 can pass through bottom prism sheet 634, diffuser sheet 636 and top second prism sheet 638. As illustrated, the plurality of LEDs 630 can emit light in a plurality of directions. Individual beams of light emitted by the LEDs 630 may have varying path lengths between the LED and the layers 632, 634, 636, and 638. For instance light beams 640 may have a shorter path through the layers than light beams 642. This difference in path length can create a difference in the amount of mixing an individual light beam encounters before being viewed by a user, with shorter light beams having less mixing than longer light beams. This inconsistency in mixing can lead to the appearance of hotspots as discussed above. An optical coating 642 such as those discussed above can be applied locally to an area in which light with a shorter path length may create a hotspot. As illustrated, an optical coating 642 can be disposed in an area above quantum dot sheet 632 that corresponds to the area that is impinged upon by light beams 640. Light beams 640 have a shorter path length as discussed above, and thus may require an optical coating to remedy hotspots that may occur due to the shorter mixing distance.

If LEDs 630 emit blue light as they might in a quantum dot display, the hotspots can appear as blue spots on the image. This can also be true of displays that utilize a YAG phosphor. In display configurations that don't contain a phosphor or quantum dot sheet, the hotspots may appear as bright spots on an image. The optical coating 642 can help to mitigate the appearance of the bright spots on a display image.

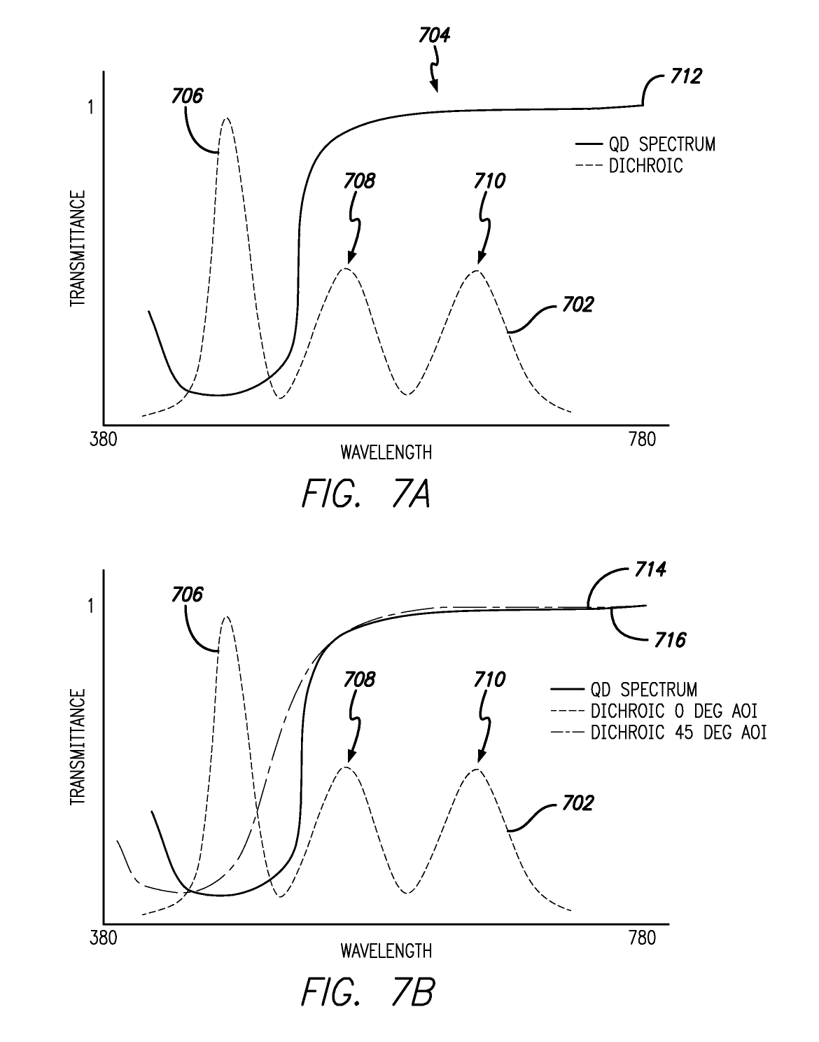

In some examples, an optical coating can be implemented using a dichroic film. The dichroic film can act as a filter that allows red and green light to pass through the filter, while attenuating the blue light, so as to normalize the intensity of the blue light relative to the red and green light. FIG. 7A illustrates an exemplary frequency response of a dichroic film that can be used as an optical coating. As illustrated, the colors of light emitted by a quantum dot can be represented by the spectral response 702. The three peaks 706, 708, and 710 of the spectral response 702, correspond to the three colors of light blue, green and red respectively. In order to attenuate the blue light, and thus reduce mitigate hotspots; the dichroic film can be configured such that it is an optical filter that has a spectral response similar to curve 712. As shown, when light is passed through a dichroic film with spectral response 712, the blue light can be attenuated, and the red and green light can be allowed to pass through with minimal attenuation. By attenuating the blue light, which may have a heightened intensity as compared to the red and green light (as discussed above), the appearance of hotspots can be minimized.

FIG. 7B illustrates another exemplary frequency response of a dichroic film that can be used as an optical coating. In this example, the dichroic film can be configured such that its spectral response changes as a function of the angle of incidence of the light impinging upon it. For instance, spectral response 714 can represent the spectral response of a dichroic film when light impinges on the film at a 0° angle relative to a line perpendicular to the plane of the display. Spectral response 716 can represent the spectral response of the same dichroic film when light impinges on the film at a 45° angle relative to a line perpendicular to the plane of the display. As shown, spectral response 714 attenuates blue light to a greater extent relative to spectral 716. In a backlight system, in which light impinging the dichroic film at 0° has more intensity than light impinging the dichroic film at 45°, the dichroic film with a response illustrated in FIG. 7B can provide the normalization necessary to mitigate hotspots. One skilled in the art will recognize that the above FIGS. 7A and 7B are only examples and that spectral response of the dichroic film can be configured to produce a spectral response with as much attenuation necessary at any angle of incidence of light as is necessary to mitigate hotspots for any particular backlight.

While not illustrated, in another example, the optical coating can be a diffuser. The diffuser can act similarly to the reflective coating and the dichroic film discussed above, to selectively attenuate blue light so as to normalize the intensity of blue, green and red light, thus mitigating the appearance of hotspots on the display.

The optical coatings discussed above can also be applied to a backlight architecture that contains a YAG phosphor as discussed in FIG. 3. In some examples, the optical coating can be a separate layer of material placed between the YAG phosphor 304 and light guide 308. In other examples, the optical coating can be applied directly on the YAG phosphor 304. The optical coating in a YAG phosphor can use the same mechanisms to mitigate hotspots as discussed above in reference to backlights that use a quantum dot sheet to produce colors.

In the example of hotspots being caused by LED position, the optical coating can be disposed in different locations depending on the LED configuration. For example, in a direct view configuration, described above, the optical coating can be disposed directly on the LED. In an edge emitting configuration, also described above, the optical coatings can be disposed on the quantum dots located on or near the edge of the active area where the LEDs are located. In other examples of edge emitting LED architectures they can be disposed either slightly below or slightly above the active area parallel to the edge of the active area in which the LEDs are located.

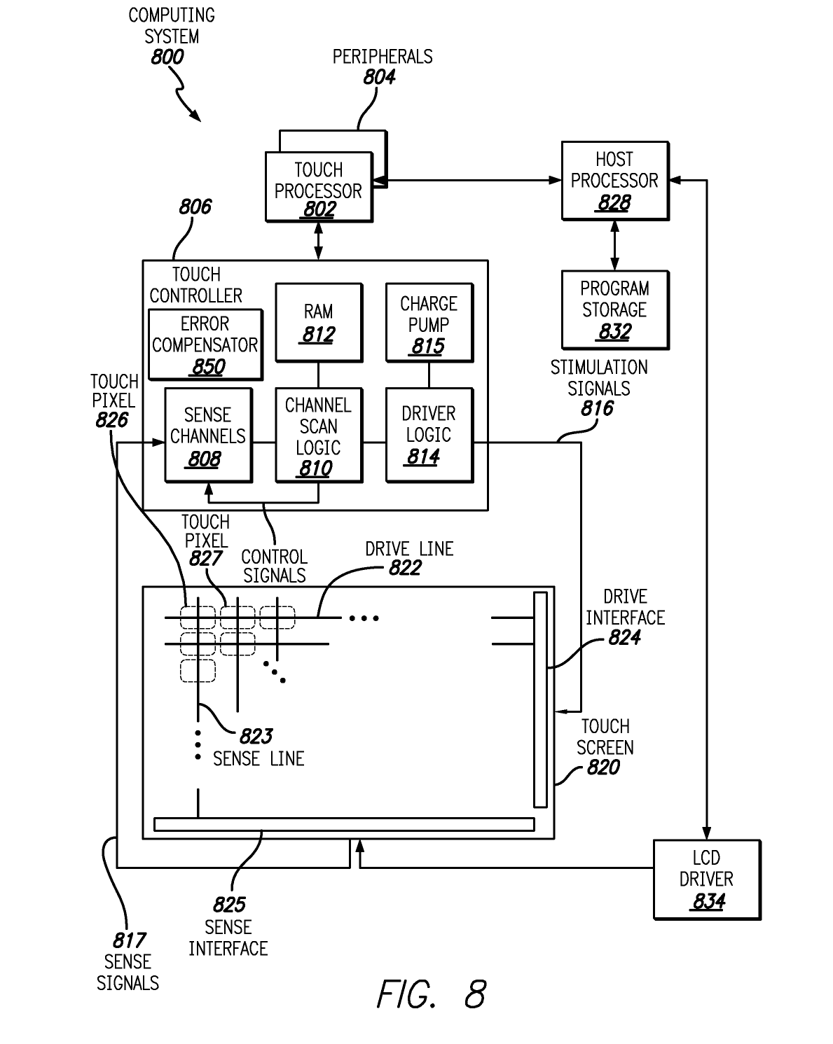

FIG. 8 is a block diagram of an example computing system that illustrates one implementation of an example display with the optical coating to mitigate hotspots quantum dots according to examples of the disclosure. Computing system 1000 could be included in, for example, mobile telephone 136, digital media player 140, personal computer 144, or any mobile or non-mobile computing device that includes a touch screen. Computing system 800 can include a touch sensing system including one or more touch processors 802, peripherals 804, a touch controller 806, and touch sensing circuitry. Peripherals 804 can include, but are not limited to, random access memory (RAM) or other types of memory or storage, watchdog timers and the like. Touch controller 806 can include, but is not limited to, one or more sense channels 808, channel scan logic 810 and driver logic 814. Channel scan logic 810 can access RAM 812, autonomously read data from the sense channels and provide control for the sense channels. In addition, channel scan logic 810 can control driver logic 814 to generate stimulation signals 816 at various frequencies and phases that can be selectively applied to drive regions of the touch sensing circuitry of touch screen 820, as described in more detail below. In some examples, touch controller 806, touch processor 102 and peripherals 804 can be integrated into a single application specific integrated circuit (ASIC).

Computing system 800 can also include a host processor 828 for receiving outputs from touch processor 802 and performing actions based on the outputs. For example, host processor 828 can be connected to program storage 832 and a display controller, such as an LCD driver 834. Host processor 828 can use LCD driver 834 to generate an image on touch screen 820, such as an image of a user interface (UI), and can use touch processor 802 and touch controller 806 to detect a touch on or near touch screen 820, such a touch input to the displayed UI. The touch input can be used by computer programs stored in program storage 832 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 828 can also perform additional functions that may not be related to touch processing.

Integrated display and touch screen 820 can include touch sensing circuitry that can include a capacitive sensing medium having a plurality of drive lines 822 and a plurality of sense lines 823. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 822 can be driven by stimulation signals 816 from driver logic 814 through a drive interface 824, and resulting sense signals 817 generated in sense lines 1723 can be transmitted through a sense interface 825 to sense channels 808 (also referred to as an event detection and demodulation circuit) in touch controller 806. In this way, drive lines and sense lines can be part of the touch sensing circuitry that can interact to form capacitive sensing nodes, which can be thought of as touch picture elements (touch pixels), such as touch pixels 826 and 827. This way of understanding can be particularly useful when touch screen 820 is viewed as capturing an “image” of touch. In other words, after touch controller 806 has determined whether a touch has been detected at each touch pixel in the touch screen, the pattern of touch pixels in the touch screen at which a touch occurred can be thought of as an “image” of touch (e.g. a pattern of fingers touching the touch screen).

In some examples, touch screen 820 can be an integrated touch screen in which touch sensing circuit elements of the touch sensing system can be integrated into the display pixels stackups of a display.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the appended claims.

Accordingly, in view of the above, some examples of the disclosure relate to a backlight for a display screen, the backlight comprising: one or more light sources and one or more optical coatings disposed proximal to the one or more light sources and configured for reducing non-uniformities in light intensity on the display screen. Additionally or alternatively to one or more of the examples disclosed above, the optical coating is disposed on a layer of material and the layer of material is disposed on top of a light guide of the backlight. Additionally or alternatively to one or more of the examples disclosed above, the optical coating is applied directly on the light guide. Additionally or alternatively to one or more of the examples disclosed above, the optical coating is patterned to correspond to the position of the one or more light sources. Additionally or alternatively to one or more of the examples disclosed above, the optical coating is a reflective coating. Additionally or alternatively to one or more of the examples disclosed above, the optical coating is a diffusive coating. Additionally or alternatively to one or more of the examples disclosed above, the optical coating is a dichroic film. Additionally or alternatively to one or more of the examples disclosed above, the backlight further comprises a quantum dot sheet disposed above the backlight, and the one or more optical coatings are disposed above the quantum dot sheet. Additionally or alternatively to one or more of the examples disclosed above, the quantum dot sheet comprises one or more quantum dots, and the quantum dots are configured to emit light with a plurality of colors. Additionally or alternatively to one or more of the examples disclosed above, the one or more light sources are light emitting diodes and the light emitting diodes are top emitting diodes. Additionally or alternatively to one or more of the examples disclosed above, the one or more light sources are light emitting diodes and the light emitting does are side emitting diodes.

Other examples of the disclosure relate to a method of forming a display to the reduce the effects associate with display hotspots, the method comprising: locating one or more light sources within a backlight of the display and locating one or more optical coatings within the backlight, wherein the one or more optical coatings are configured for reducing non-uniformities of light intensity on the display. Additionally or alternatively to one or more of the examples disclosed above, the method further comprises placing the optical coating on a layer of material, and locating the layer of material above a light guide, the light contained within the backlight of the display. Additionally or alternatively to one or more of the examples disclosed above, the method further comprises placing the optical coating directly on the light guide. Additionally or alternatively to one or more of the examples disclosed above, the optical coating is patterned to correspond to the position of the one or more light sources. Additionally or alternatively to one or more of the examples disclosed above, the optical coating is a reflective coating. Additionally or alternatively to one or more of the examples disclosed above, the optical coating is a diffusive coating. In other examples the optical coating is a dichroic film. Additionally or alternatively to one or more of the examples disclosed above, the method further comprises locating a quantum dot sheet above the backlight and placing the optical coating above the quantum dot sheet. Additionally or alternatively to one or more of the examples disclosed above, the quantum dot sheet comprises one or more quantum dots, and the quantum dots are configured to emit light with a plurality of colors. Additionally or alternatively to one or more of the examples disclosed above, the one or more light sources are light emitting diodes and the light emitting diodes are top emitting diodes. Additionally or alternatively to one or more of the examples disclosed above, the one or more light sources are light emitting diodes and the light emitting does are side emitting diodes.

What is claimed is:

1. A backlight for a display screen, the backlight comprising:
one or more light sources; and
one or more optical coatings disposed proximal to the one or more light sources and configured for reducing non-uniformities in light intensity on the display screen.

2. The backlight of claim 1, wherein the optical coating is disposed on a layer of material, and the layer of material is disposed on top of a light guide of the backlight.

3. The backlight of claim 2, wherein the optical coating is applied directly on the light guide.

4. The backlight of claim 1, wherein the optical coating is patterned to correspond to a position of the one or more light sources.

5. The backlight of claim 1, wherein the optical coating is a reflective coating.

6. The backlight of claim 1, wherein the optical coating is a diffusive coating.

7. The backlight of claim 1, wherein the optical coating is a dichroic film.

8. The backlight of claim 1, further comprising a quantum dot sheet disposed above the backlight and wherein the one or more optical coatings are disposed above the quantum dot sheet.

9. The backlight of claim 8, wherein the quantum dot sheet comprises one or more quantum dots, and the quantum dots are configured to emit light with a plurality of colors.

10. The backlight of claim 1, wherein the one or more light sources are light emitting diodes and the light emitting diodes are top emitting diodes.

11. The backlight of claim 1, wherein the one or more light sources are light emitting diodes and the light emitting diodes are side emitting diodes.

12. A method of forming a display, the method comprising:
locating one or more light sources within a backlight of the display; and
locating one or more optical coatings within the backlight, wherein the one or more optical coatings are configured for reducing non-uniformities in light intensity on the display.

13. The method of claim 12, further comprising placing the optical coating on a layer of material, and locating the layer of material above a light guide, the light guide contained within the backlight of the display.

14. The method of claim 13, further comprising placing the optical coating directly on the light guide.

15. The method of claim 12, wherein the optical coating is patterned to correspond to a position of the one or more light sources.

16. The method of claim 12, wherein the optical coating is a reflective coating.

17. The method of claim 12, wherein the optical coating is a diffusive coating.

18. The method of claim 12, wherein the optical coating is a dichroic film.

19. The method of claim 12 further comprising locating a quantum dot sheet above the backlight and placing the optical coating above the quantum dot sheet.

20. The method of claim 19, wherein the quantum dot sheet includes one or more quantum dots, and the quantum dots are configured to emit light with a plurality of colors.
